(19) United States
(12) Patent Application Publication
(10) Pub. No.: US 2011/0269007 A1
(43) Pub. Date: Nov. 3, 2011

(54) HIGH RATE SEAWATER ACTIVATED LITHIUM BATTERY CELLS BI-POLAR PROTECTED ELECTRODES AND MULTI-CELL STACKS

(75) Inventors: Steven J. Visco, Berkeley, CA (US); Yevgeniy S. Nimon, Danville, CA (US); Lutgard C. De Jonghe, Lafayette, CA (US); Bruce D. Katz, Orinda, CA (US)

(73) Assignee: PolyPlus Battery Company, Berkeley, CA (US)

(21) Appl. No.: 12/973,779

(22) Filed: Dec. 20, 2010

Related U.S. Application Data
(60) Provisional application No. 61/329,829, filed on Apr. 30, 2010.
(60) Provisional application No. 61/373,732, filed on Aug. 13, 2010.
(60) Provisional application No. 61/378,317, filed on Aug. 30, 2010.

(51) Int. Cl. H01M 10/02

(52) U.S. Cl. 429/119; 429/118; 429/210

(57) ABSTRACT

Water activated alkali metal battery cells, protected anode bi-polar electrodes and multi-cell stacks are configurable to achieve very high energy density. The cells, bi-polar electrode and multi-cell stacks include a protected anode and a cathode having a solid phase electro-active component material that is reduced during cell discharge.

### CROSS-REFERENCE TO RELATED APPLICATIONS

This application claims priority to U.S. Provisional Patent Application No. 61/329,829 filed Apr. 30, 2010, titled HIGH RATE LI/SEAWATER ACTIVATED BATTERY; and U.S. Provisional Patent Application No. 61/373,732 filed Aug. 13, 2010, titled HIGH RATE LI/SEAWATER ACTIVATED BATTERY; and U.S. Provisional Patent Application No. 61/378,317 filed Aug. 30, 2010, titled HIGH RATE LITHIUM SEAWATER ACTIVATED BATTERY. Each of these prior applications is incorporated herein by reference in its entirety and for all purposes.

### BACKGROUND OF THE INVENTION

1. Field of the Invention

The present invention relates generally to electrochemical energy storage devices. More particularly, this invention relates to water (e.g., seawater) activated alkali metal (e.g., lithium) battery cells and multi-cell stacks thereof. In various embodiments the battery cell has a highly compact cell configuration and can be discharged in seawater at high current density with minimal or no gas evolution or sludge formation. In various embodiments the seawater activated battery cell has a protected lithium electrode (as anode) and a cathode preloaded with a solid electro-active component material that, during high rate discharge, is preferentially electro-reduced over constituents of seawater, and in particular that of water and dissolved oxygen.

2. Description of Related Art

Global issues are increasing the need for and expanding the role of underwater devices to monitor, survey, and explore oceans, harbors and coastal water systems. Underwater deployments and subsea applications abound. Examples include i) oil and gas companies evaluating the viability of an offshore field, or constructing, maintaining and operating offshore rigs, or responding to a catastrophic event (such as the recent oil spill off the Gulf Coast of the United States); ii) sovereign nations conducting surveillance of their harbors and littoral zones, or performing underwater ship inspections or naval reconnaissance; and iii) the oceanographic community observing and collecting data on seismic activity and aquatic ecosystems. Underwater power sources, and in particular batteries, are needed to enable or otherwise support the ever expanding role of these underwater applications.

Lithium metal is generally recognized as the holy grail of battery material. Though corroded in seawater and ambient air, the lightweight and large negative electrochemical potential of lithium makes fully sealed lithium batteries very attractive for underwater devices in need of high specific energy (Wh/kg) power sources. Fully sealed lithium batteries may be used underwater because they have a closed cell architecture wherein the electrodes and electrolyte are hermetically disposed in a cell container out of contact with the external environment. Of these, lithium thionyl chloride (Li/SOCl₂) primary batteries are the most common, and secondary lithium ion batteries are also used underwater where short run times are acceptable and the application is amenable to charge. To operate a fully sealed lithium battery underwater generally requires some form of pressure compensation or a pressure tolerant housing that significantly burdens cell energy density and weight. Moreover, thionyl chloride cells are highly toxic and removal of that battery after underwater deployment presents a serious safety hazard, especially after it has been discharged at high rate.

However, lithium metal in direct contact with seawater is not feasible due to the corrosion reaction of lithium and seawater.

### SUMMARY OF THE INVENTION

A viable lithium battery that is open to the seawater environment and therefore operable without a pressure housing would provide tremendous benefit for underwater applications. Such a viable Li/Seawater cell for enduring use underwater, and therefore widespread application, has depended upon finding a practical lithium electrode that does not corrode in water. Water stable protected lithium electrodes are described in applicant's co-pending patent applications US Patent Application No.: 2007/0037058 and US Patent Application No.: US 2007/0051620 to Visco et al.,. In some constructions the protected electrode includes a lithium metal foil or sinter and at least one major surface defined by a lithium ion conductive protective membrane architecture that is substantially impervious to and chemically compatible in contact with water and therefore the protected electrode is suitable for use in aqueous batteries.

The advent of protected electrodes, as described in the above references, has enabled a broad new class of aqueous based lithium batteries, including an exceptionally lightweight Li/seawater battery cell for which the operating environment, namely seawater, serves not only to provide the cell with electrolyte but also to depolarize the cathode. With the electrolyte and cathode active material provided by the seawater itself, and with lithium metal the lightest and most energetic battery material known, protected lithium seawater batteries approach the theoretical specific energy limit of what is viable for an underwater battery cell.

Global issues of the day are bringing underwater applications to the forefront, and along with that there is a critical need for an enduring lightweight underwater battery that can support the ever-increasing power demands and run time requirements of underwater devices and systems. The present invention addresses this need by providing a highly compact protected lithium electrode seawater battery cell capable of high rate discharge for extended periods, and an energy dense multi-cell stack of bi-polar protected electrodes.

In one aspect the invention provides a water activated alkali-metal battery cell having a protected alkali-metal anode and a cathode having a solid phase electro-active component material that, in various embodiments, precludes the reduction of seawater, and, in certain embodiments produces on high rate discharge a lithium salt highly soluble in water. By this expedient, sludge and hydrogen gas are not produced, and the present invention leads to a highly compact cell that may be discharged at high rates over extended periods with a low noise footprint. Thus the cells of the instant invention are especially useful for powering underwater devices and systems such as unmanned underwater vehicles (UUVs), sonobuoys, and sensors.

The cell and multi-cell battery of the present invention may be, and generally are, activated upon addition of water or immersion or submergence of the cell into a body of water, such as a sea or ocean environment, and typically for the purpose of providing electrical power to an underwater device or system. Because the cathode contains a solid electro-active component material, the instant battery cell is not rate limited by diffusion of oxygen to the cathode, and may be discharged at rates commensurate with the power demands for vehicular propulsion, and thereby enables a significant increase in the service life of, or distance traveled by, underwater vehicles, or the run time of accessory components, such as when the multi-cell battery is used as an on-board auxiliary power unit.

The instant cells have an open architecture, which means the cells are physically open to the external environment for receiving aqueous liquid upon activation, and typically remain open during cell operation. By this expedient the cells and multi-cell stacks have extremely light transport weight because they may be stored without aqueous liquid until the time of deployment or activation. The cells are generally deployed for operation and activated simultaneously in the same external environment. For instance the cell or multi-cell stack, absent aqueous liquid, may be dropped into the ocean wherefrom aqueous liquid (i.e., seawater) enters the cell to activate it and the cell is subsequently operated in the ocean wherefrom seawater may permeate, or in some embodiments flow, through the cell. However, it is contemplated herein that the cells may be activated prior to deployment (i.e., pre-deployment activated or more simply pre-activated) as a mechanism of priming the cell for deployment. Pre-activating the battery cell can be particularly beneficial for those applications that demand immediate start-up.

In accordance with the instant invention the battery cell of the present invention includes a protected alkali metal anode (e.g., a protected lithium electrode) and a cathode having a solid phase electro-active component material.

The protected anode includes a lithium electro-active component material (e.g., a sheet of lithium metal foil) hermetically sealed inside an anode enclosure having a wall component comprising a water impermeable lithium ion conducting protective membrane architecture. The membrane architecture has an interior surface opposing the alkali metal electro-active component material and an exterior surface opposing the exterior environment about the anode enclosure.

The anode enclosure protects the lithium foil from direct contact (i.e., touching contact) with seawater (i.e., the external environment) and allows lithium ions to migrate out of the enclosure via the protective membrane architecture during cell discharge.

Alkali metal electroactive component materials suitable for use herein include lithium and sodium electroactive materials such as lithium metal, sodium metal, lithium alloys (e.g., LiAl), sodium alloys and intercalation materials (e.g., lithium metal, lithium alloys, and lithium intercalation host materials such as graphitic like carbons).

The cathode, generally sheet-like, has an active surface composed of a solid phase electro-active component material (e.g., AgCl), and optionally a current collector. For instance, the cathode may be a sheet of silver chloride adhered to a silver metal current collector. In various embodiments the electrodes are arranged having the cathode active surface opposing the exterior surface of the membrane architecture. In some embodiments thereof the electrodes are disposed in a spaced apart relationship such that the membrane architecture exterior surface does not come into direct contact with the cathode active surface. In other embodiments those surfaces do touch (i.e., direct contact) and the cell has what is termed herein a zero-gap.

The cell also includes an inter-electrode region for receiving aqueous liquid (e.g., seawater) upon activation, and therein the aqueous liquid directly contacts at least a portion of the protective membrane exterior surface and at least a portion of the cathode active surface. Seawater in the inter-electrode region serves as an electrolytic solution in the cell for passing ionic current, as a sink for accepting ions released by the electrodes during discharge, and as a reservoir wherein discharge products form. Prior to activation the inter-electrode region is typically devoid of aqueous liquid (e.g., seawater), and is ultimately filled or impregnated with seawater when activated.

The present invention provides many advantages for underwater devices for which power density and volume are foremost considerations, and especially for those applications wherein acoustic noise is prohibitive and high rate discharge is required. In various embodiments, the cells of the present invention are highly compact and configured to operate at high rates of discharge over long periods of time and with an exceptionally low noise footprint, or none at all.

In various embodiments, the solid electro-active component material in the cathode is preferentially electro-reduced over seawater at high rates of discharge, and the cell reaction produces a highly water soluble lithium salt (e.g., LiCl), thus enabling the construction of a highly compact cell capable of discharging at high rates over extended periods without generating sludge that would otherwise polarize the cell or evolving hydrogen gas that might otherwise lead to bubble manifested acoustic noise.

In certain embodiments the cathode solid phase electro-active component material is a conversion compound that when electro-reduced releases a highly soluble anion into the seawater. In certain embodiments thereof the anion released is preferably not hydroxide ions, and the conversion compound is sometimes referred to herein as non-base generating. In particular embodiments the solid phase electro-active component material of the cathode is a metal halogen such as a metal halide, for instance a metal chloride, metal iodide or metal fluoride; e.g., silver chloride (AgCl) or copper chloride (CuCl).

To facilitate uniform depletion of lithium during discharge, it is preferable to configure the cell such that the apparent area of the cathode active surface is greater than the apparent area of the protective membrane architecture exterior surface, and for the cathode active surface to radially extend beyond the perimeter of the membrane exterior surface.

The ability to circumvent sludge at high rates of discharge enables the construction of a highly compact cell having a separation distance between the protected anode and cathode (sometimes referred to herein as the gap thickness) that is negligible relative to the overall thickness of the cell (e.g., less than 10%, preferably less 5% and even more preferably less than 2%), and in some embodiments the cell is configured with a zero-gap—the electrodes in direct contact with each other.

In various embodiments the protected anode and cathode are disposed in a spaced apart relationship therewith defining an inter-electrode region, and the gap thickness may be defined by the relative position of the electrodes affixed to an external frame or by a spacer component positively separating the electrodes from each other.

In various embodiments the spacer component is interposed between and in direct contact with at least one of the membrane architecture exterior surface or the cathode active surface, and typically both surfaces. For instance the spacer component may be a frame-like structure having a porous wall component, a porous material layer, an arrangement of discrete material elements, or a seawater flow retardant membrane or gasket, or some combination thereof.

In other embodiments the spacer component is positioned outside the perimeter of the cathode active surface and that of the membrane exterior surface, and there disposed does not directly contact either surface. For instance the spacer may be sandwiched between a pair of spacer support components each having a support surface and a distal and proximal end. The first spacer support conjoined to the cathode and the second to the protected anode. The proximal ends of the support component are conjoined to their respective electrodes and the distal ends extend radially outward away from the electrodes and the spacer component is sandwiched between the supporting surfaces in direct contact.

When interposed between the protected anode and the cathode active surface, the spacer components are sometimes referred to herein as interior spacers because they are within the interior perimeter of the cell, and spacer components that are disposed outside perimeter of the cell are sometimes referred to herein as exterior spacers. Suitable exterior spacers include framelike structures having a porous wall, an arrangement of discrete material elements, and seawater flow retardant gaskets (e.g., hydrogel, water swellable polymer, a micro-porous polymer and cellulosic paper).

In certain embodiments the spacer component suppresses and preferably precludes the bulk motion (flow) of seawater into or through the gap, and the spacer component is sometimes referred to herein as a flow retardant gasket (if in such form) or as a flow retardant membrane when disposed as a layer substantially covering most if not all of the electrode active surfaces. The flow retardant spacer suppresses the bulk motion of seawater through the gap but does not prevent seawater from permeating into the gap via diffusion, capillary action or osmosis. Suitable flow retardant separators and gaskets include hydrogels, water swellable polymers, micro-porous polymer membranes and cellulosic paper.

The flow retardant spacers provide a number of benefits. Firstly it provides a mechanism to limit leakage currents associated with seawater serving as a common electrolyte for cells that are series connected in a multi-cell stack; and secondly it provides a mechanism to retain discharge product nearby the active surface of the protected anode in order to lessen the rate of ion exchange between lithium ions in the protective membrane architecture and sodium ions in seawater.

When used, flow retardant spacers may reduce the rate of cell activation, i.e., the time it takes for a sufficient amount of seawater to enter the cell in direct contact with the protective membrane and cathode. In one embodiment the flow retardant spacer (e.g., a flow retardant separator or gasket) juts out of the cell, radially extending beyond the perimeter of the cathode and that of the protected anode, and there disposed in the seawater environment serves as a wick to permeate seawater into the gap.

In various embodiments the cell further comprises a solid phase salt (e.g., a hydroscopic salt), typically in the inter-electrode region, that dissolves during activation, and serves to boost conductivity and generally enhance startup performance. In certain embodiments the solid salt is a lithium salt, and functions to improve stability of the protective membrane during the early stages of discharge by lessening ion exchange with sodium ions. In a particular embodiment the salt is compacted in direct contact with the flow retardant separator, and by this expedient has been found to enhance activation rate.

In other embodiments the thickness of the gap is zero, and the cell has what is termed herein a “zero-gap.” Zero-gap cells are not absent an inter-electrode region, and as described later the inter-electrode region of a zero-gap cell may be defined by the porosity of the cathode or by the difference in surface morphology of the electrodes in direct contact. For instance, wherein such contact creates an interconnected network of channels for seawater to permeate.

In various embodiments the cell is a hybrid construct, and includes an electron transfer medium for electro-reducing dissolved oxygen from the external environment in which the cell operates, typically electro-catalyzed to facilitate the reaction. In certain embodiments the electron transfer medium is electronically connected to but not in direct contact with the solid phase electro-active component material of the cathode.

In another aspect the invention provides a compact multi-cell stack comprised of the instant battery cells electrically arranged in a parallel, series or series-parallel arrangement. In certain embodiments the cells are configured such that when electrically arranged in series the stack exhibits minimal leakage current, and thus the battery of the instant invention is intrinsically capable of efficient operation at voltages greater than that of the individual cells that make up the stack. Typically the cells in a given stack are substantially identical.

In yet another aspect the present invention provides a novel bi-polar protected alkali metal electrode and a bipolar battery thereof.

In various embodiments the bipolar electrode is constructed from a single sided protected anode and a single sided cathode. The bi-polar electrode has two opposing active surfaces, a first active surface provided by the protected anode active surface and a second active surface provided by the cathode active surface. Typically the protected anode and cathode are centroidally aligned such that the protected anode second surface (i.e., exterior surface of the anode backplane) is adjacent to and opposes the second surface of the cathode (i.e., current collector surface); the two surfaces in electronic contact.

In some embodiments the cathode and anode share a common collector. For instance the cathode active layer formed on the anode backplane. In other embodiments the protected anode and cathode each have their own discrete current collector in electronic contact.

In various embodiments the bipolar battery is constructed of a stacking of two or more of the instant bipolar protected electrodes, wherein adjacent bi-polar electrodes are configured such that the protected anode active surface of the first bi-polar electrode is adjacent to and opposes the cathode active surface of the second bi-polar electrode. In some embodiments the bipolar electrodes in the stack are positively separated from each other by a spacer component, e.g., a flow retardant membrane (or gasket). In other embodiments the bi-polar protected electrodes are stacked in direct contact with each other, thus forming a bipolar battery of zero-gap cells (i.e., a zero-gap bipolar battery).

### BRIEF DESCRIPTION OF THE DRAWINGS

FIGS. 1A-B illustrate a cross sectional depiction and a perspective view of a battery cell in accordance with one embodiment of the present invention.

FIGS. 2A-B illustrate a cross sectional depiction and a perspective view of a battery cell in accordance with one embodiment of the present invention.

FIGS. 3A-3B illustrate alternative configurations of a protected anode suitable for use in a battery cell and multi-cell stack of the present invention.

FIGS. 4A-D illustrate various alternative configurations of a protective membrane architecture in accordance with the present invention.

FIGS. 5A-B schematically illustrates a cross sectional depiction of two embodiments of a battery cell in accordance with one embodiment of the present invention.

FIG. 6A-B schematically illustrates a cross sectional depiction and a perspective view of a battery cell in accordance with one embodiment of the present invention.

FIGS. 7A-B schematically illustrates a cross sectional depiction and a perspective view of a battery cell in accordance with one embodiment of the present invention

FIGS. 8A-B schematically illustrates a cross sectional depiction and a perspective view of a battery cell in accordance with one embodiment of the present invention

FIGS. 9 schematically illustrates a cross sectional depiction of one embodiment of a battery cell in accordance with one embodiment of the present invention.

FIGS. 10A-B illustrates a perspective view of a cathode suitable for use in a battery cell in accordance with the present invention, and a cross sectional depiction of an inter-electrode region of a battery cell in accordance with the present invention.

FIG. 11A-B illustrates a perspective view of a cathode suitable for use in a battery cell in accordance with the present invention, and a cross sectional depiction of the cathode.

FIG. 12A-B illustrate alternative configurations of a cathode for use in a battery cell and multi-cell stack of the present invention.

FIG. 13. schematically illustrates a cross sectional depiction of a bi-polar protected electrode in accordance with one embodiment of the present invention.

FIG. 14. schematically illustrates a cross sectional depiction of a bi-polar protected electrode multi-cell stack in accordance with one embodiment of the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in details so as to not unnecessarily obscure the present invention.

When used in combination with “comprising,: “a method comprising,” “a device comprising” or similar language in this specification and the appended claims, the singular forms “a,” “an,: and “the” include plural reference unless the context clearly dictates otherwise. Unless defined otherwise, all technical and scientific terns used herein have the same meaning as commonly understood to one of ordinary skill in the art to which this invention belongs.

In the figures, like reference numbers indicate identical or functionally similar elements.

The invention is now described with respect to embodiments of a water activated alkali metal battery, namely a seawater activated lithium battery cell wherein the external environment into which the cell is immersed or submerged for activation and operation is a seawater environment, such as an ocean, and the aqueous liquid which enters the inter-electrode region and therein activates the cell is seawater from that ocean environment. Once manufactured the cell is typically stored in an inactive state and devoid of aqueous liquid until activated. However, it is contemplated that the cell may be activated (or activation started) just prior to deployment in the ocean (i.e., pre-activated); for instance, by placing the cell in a salt water bath, e.g., a lithium salt solution (e.g., LiCl or LiBr).

Seawater Activated Lithium Battery Cell

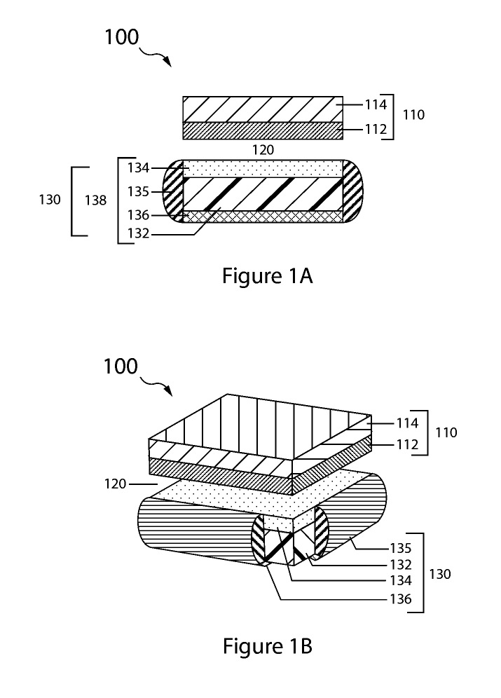

A seawater activated lithium battery cell in accordance with one embodiment of the present invention is illustrated in FIGS. 1A and 1B and described in detail below.

The battery cell 100 has an open architecture that includes a protected lithium electrode 130 (i.e., a protected anode) and a cathode 110. Typically, the electrodes are arranged such that the active surface of the cathode opposes the active surface of the protected anode (as shown), but the invention is not limited as such and it is contemplated that the electrodes may be arranged, for example, in a side-by-side relationship.

Sometimes herein below, for making reference to the cathode active surface or the protected anode active surface the term “electrode active surface” is used or when referring to both, “electrode active surfaces.”

The cathode 110, generally sheet-like, has an active surface composed of an electro-active component layer 112 comprising a solid phase electro-active component material (e.g., AgCl). The cathode may also have an optional current collector 114 that is adhered to the electro-active layer 112, and thereon provides the backside of the cathode. For instance, the cathode may be a sheet of silver chloride (electro-active layer) adhered to a silver metal current collector.

Herein above and below, when making reference to the active surface of the cathode (i.e., the “cathode active surface”), it means that surface of the cathode in direct contact with the electrolytic solution of the cell (i.e., seawater in the inter-electrode region) and whereon electro-reduction of the solid phase electro-active component material takes place.

The protected anode 130 includes a lithium electro-active component 132 (e.g., a sheet of lithium metal foil) hermetically sealed inside an anode enclosure 138 which has at least one wall component defined by a water impermeable lithium ion conducting protective membrane architecture 134 and a second wall component referred to herein as the anode backplane 136. The enclosure 138 is sealed about the lithium foil 132 via a seal structure 135 interfacing (e.g., by bonding) with the anode backplane 136 and the protective membrane 134. The backplane, as described in more detail below, may be a second protective membrane architecture, or a current collector or a substrate support. The anode enclosure 138 protects the lithium foil from direct contact with seawater, and lithium ions migrate out of the enclosure via the protective membrane architecture during cell discharge.

The cell 100 also includes an inter-electrode region 120 for receiving seawater from the external environment (e.g., the ocean) in which the cell is activated, and therein the seawater directly contacts at least a portion of the protective membrane exterior surface and at least a portion of the cathode active surface. Seawater in the inter-electrode region serves as an electrolytic solution for passing ionic current, as a sink for accepting ions released by the electrodes during discharge, and as a reservoir where discharge products form. Prior to activation the inter-electrode region is typically devoid of seawater (i.e., it is entirely missing), and is ultimately filled or impregnated with seawater when activated.

The inter-electrode region 120 may be of various forms. A first type of inter-electrode region is defined by the spaced apart relationship between the exterior surface of the protective membrane architecture and the cathode active surface, as illustrated in FIG. 1. Because the electrodes are spaced apart, this type of region is sometimes referred to herein as the gap between the electrodes, or more simply the gap. A second type of inter-electrode region is defined by the internal porosity of the cathode that extends up to the cathode active surface. And a third type of inter-electrode region is defined by the surface morphology of the cathode active surface in direct contact with the membrane exterior surface, e.g., channels or interpenetrating tunnels formed by the direct contact between a cathode having a rough active surface and a protected anode having a smooth protective membrane architecture exterior surface. The cell may have more than one type of inter-electrode region, and in such instances the region types are not isolated from each other but are interconnected via seawater communication.

In various embodiments a spacer component may be used to create the gap (i.e., to positively separate the electrodes).

In some embodiments the spacer component is interposed between and therein directly contacts one or both of the active cathode surface and/or the membrane exterior surface. Such spacers may be referred to as “interior spacers” because they are disposed in the interior of the active portion of the cell, in direct contact with one and typically both active electrode surfaces.

In other embodiments the spacer component is disposed outside the perimeter of the electrodes and does not directly contact either of the membrane exterior surface or the cathode active surface. For instance the spacer may be sandwiched between a pair of spacer support components, one conjoined to the cathode and the other to the protected anode. The proximal ends of the support component are conjoined to their respective electrodes and the distal ends, extending radially outward away from the electrode provide the supporting surfaces between which the spacer is disposed in direct contact.

Various types of interior and exterior spacer components may be used. Briefly, some of these include porous material layers, seawater flow-retarding layers or gaskets (e.g., a hydrogel layer or gasket), or discrete material elements (e.g., polymer beads) interposed between and in direct contact with the electrodes, or a perforated frame-like structure may be placed about or outside the perimeter of the electrodes to keep them apart.

In various embodiments the gap may be created by affixing the electrodes to an external frame with the electrodes configured in spaced apart relationship. The electrodes may be attached to a single frame, or each (i.e., the cathode and the protected anode) to its own independent frame.

In accordance with the instant invention, the thickness of the gap (i.e., the distance between the spaced apart electrodes) is defined herein as the shortest distance between opposing points on the exterior surface of the protective membrane architecture and the opposing cathode active surface.

In certain embodiments the gap thickness is negligible relative to the total thickness of the cell, e.g., the gap thickness is less 10% of the total cell thickness, more preferably less than 5% and even more preferably less than 2%. For instance, the gap thickness in some embodiments is between 100 um and 50 um, or between 50 um and 25 um or between 25 and 5 um.

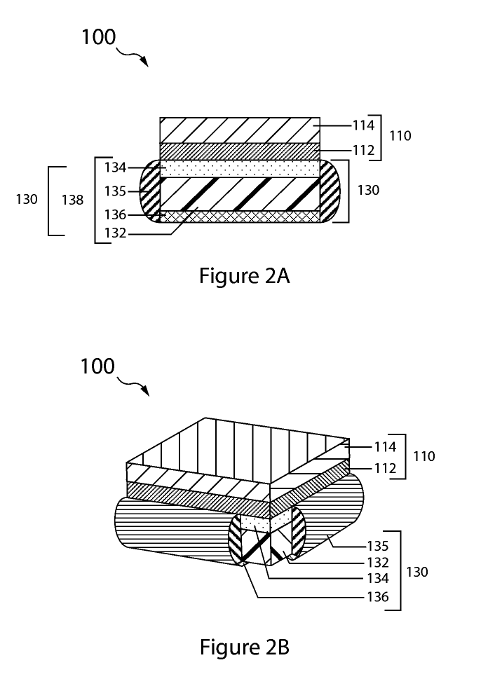

With reference to FIGS. 2A and 2B, in some embodiments the exterior surface of the protective membrane architecture directly contacts the cathode active surface, and the thickness of the gap is zero. Zero-gap cells are not absent an inter-electrode region, and as described later the inter-electrode region of a zero-gap cell may be defined by the porosity of the cathode or by channels created by the difference in surface morphology of the electrodes in direct contact.

Protected Alkali Metal Anode

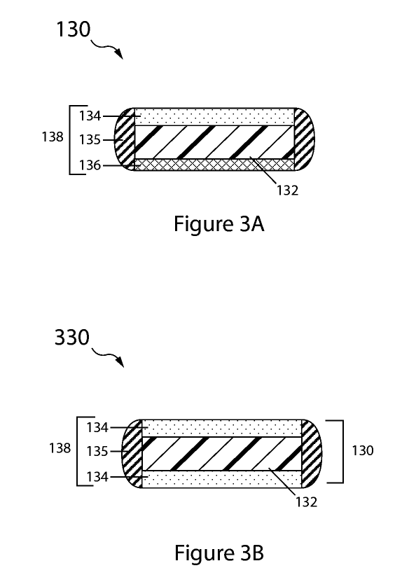

With reference to FIGS. 3A and 3B there are illustrated two embodiments of a protected alkali metal anode (e.g., a protected lithium electrode) that are particularly suitable for use in the battery cells of the present invention.

The protected anode 130 in FIG. 3A is termed single-sided which is to mean that it has one active surface out of which lithium ions migrate when the cell is discharged, and an opposing inactive surface defined by the anode backplane 136. The protected anode 330 in FIG. 3B is termed double-sided which is to mean that it has two opposing active surfaces, a first and second active surface.

With reference to both FIGS. 3A and 3B, the protected anode 130 and 330 includes a lithium electro-active component layer 132 (e.g., lithium metal foil) hermetically sealed inside an anode enclosure 138 which has a wall component defined by a lithium ion conductive protective membrane architecture 134 and another wall component, referred to herein and elsewhere, as the anode backplane 136. In various embodiments, which are described in more detail below, the anode backplane may be a second protective membrane architecture, or a current collector, or a supporting substrate. The protective membrane architecture has an interior surface facing the inside of the anode compartment and an exterior surface opposing and exposed to the external environment about the anode enclosure, and in like manner the anode backplane has an interior and exterior surface.

Herein above and below, when making reference to the active surface of the protected anode (i.e., the “protected anode active surface”) it is meant that surface in direct contact with the electrolytic solution of the cell (i.e., seawater in the inter-electrode region) and across which lithium ions migrate out of the anode enclosure during cell discharge (i.e., the exterior surface of the protective membrane architecture). In accordance with the present invention, the exterior surface of the protective membrane architecture (i.e., the protective membrane architecture exterior surface) is the active surface of the protected anode (i.e., the protected anode active surface).

The lithium electro-active component layer 132 comprises a lithium electro-active component material, and the layer is sometimes referred to herein as the anode active layer, or more simply the anode layer for the sake of simplicity. The anode layer, flat and sheet-like, is interposed between the protective membrane 134 and the backplane 136. The anode layer may be a lithium metal foil or it may be a layer of a lithium electro-active component material, such as the active coating of a lithium intercalation anode commonly employed in conventional lithium ion batteries. Suitable alkali metal electroactive component materials include lithium metal, sodium metal, lithium alloys (e.g., LiAl), sodium alloys and intercalation materials (e.g., lithium metal, lithium alloys, and lithium intercalation host materials such as graphitic like carbons); including, but not limited to, these materials in sheet, coating, sinter, and foil form (e.g., lithium metal foil).

The anode layer has two opposing surfaces, a first active surface and a second surface. In the double-sided anode embodiment 330 the second surface is active and in the single sided embodiment 130 it is inactive.

The anode layer 132 is sandwiched between the protective membrane architecture 134 and the anode backplane 136, with the first active surface of the anode layer (e.g., lithium metal foil) opposing, typically in direct contact, the interior surface of the protective membrane architecture, and the anode layer second surface opposing the interior backplane surface.

A seal structure 135 interfacing with the protective membrane architecture and anode backplane seals the anode layer in an anode compartment, and thus forms the anode enclosure 138.

With reference to FIG. 3B, the protected anode 330 is double sided and the anode backplane 134 is a second protective membrane architecture arranged in like manner to that of the first protective membrane and therefore not repeated here. With reference to FIG. 3A the protected anode 130 is single-sided, and the anode backplane 136 is not a protective membrane. In such instances the anode backplane may be electronically conductive and serve as a substrate for the anode layer and/or as a current collector, or the anode backplane may be electronically insulating, for instance the anode backplane may be contiguous with the seal structure, e.g., the seal structure a multi-layer laminate heat sealed to the exterior surface of the protective membrane architecture. As described later below, an anode backplane serving as a current collector (i.e., the exterior surface of the anode backplane) may be coated with a cathode active layer to form a bi-polar protected electrode.

The enclosure, which is formed by the protective membrane architecture and anode backplane interfacing with the seal structure 350 (e.g., joined by bonding), may be rigid or compliant. A compliant seal structure is compliant to changes in anode thickness and this property may be derived by the material properties of the seal structure, e.g., the seal structure a flexible multi-layer laminate. For instance, the compliant seal structure may be in the form of a frame sealed (e.g., by bonding) around the periphery of the backplane and membrane, and thus covers the edges of the anode layer. Typically the bond, e.g., a heat seal when the seal structure is a heat sealable multi-layer laminate, is applied to the exterior surfaces of the backplane and membrane and thereon also covers their respective edges. If rigid, the seal structure may be an open ended container, e.g., a cup shaped polymer having a recess for receiving the anode layer and the membrane architecture sealed to the lip of the cup, or the seal structure may be a rigid polymeric annulus capped on one end by the membrane and on the other end by the backplane.

Protected anodes and methods of making protected anodes having both compliant seal and rigid seals, and which are particularly suitable for use herein as a protected anode in the battery cells of the instant invention, are fully described US Patent Application No.: 2007/0037058 and US Patent Application No.: US 2007/0051620 to Visco et al., and are hereby incorporated by reference in their entirety.

The protective membrane architecture 134 is chemically stable to both the electroactive lithium layer and the external environment. The protective membrane architecture typically comprises a solid electrolyte membrane and an interlayer. The protective membrane architecture is in ionic continuity with the active anode layer and is configured to selectively transport Li ions out of the anode enclosure while providing an impervious barrier to the environment external to the anode (e.g., seawater). Protective membrane architectures suitable for use in the present invention are described in applicants' co-pending published US Applications US 2004/0197641 and US 2005/0175894 and their corresponding International Patent Applications WO 2005/038953 and WO 2005/083829, respectively, incorporated by reference herein.

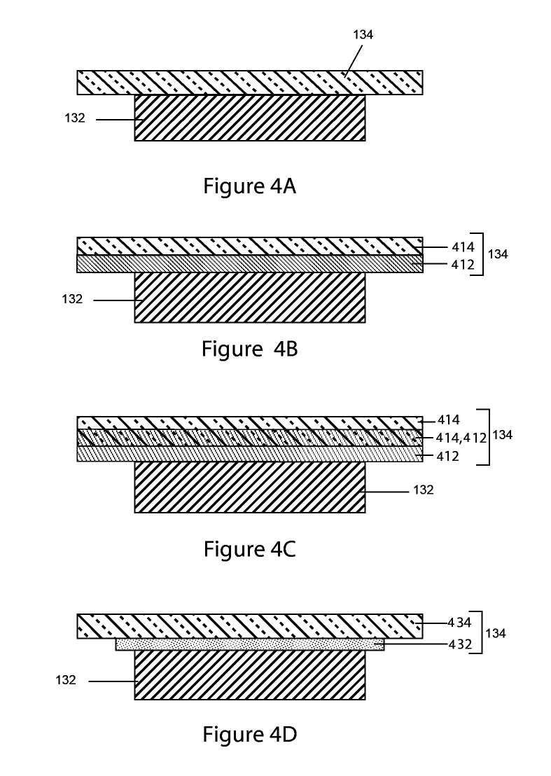

FIGS. 4A-D illustrate representative protective membrane architectures from these disclosures suitable for use in the present invention. The protective membrane architectures provide a barrier to isolate a Li anode from ambient and/or the cathode side of the cell while allowing for efficient ion Li metal ion transport into and out of the anode. The architecture may take on several forms. Generally it comprises a solid electrolyte layer that is substantially impervious, ionically conductive and chemically compatible with the external ambient (e.g., air or water) or the cathode environment.

Referring to FIG. 4A, the protective membrane architecture can be a monolithic solid electrolyte 134 that provides ionic transport and is chemically stable to both the active metal anode 132 and the external environment. Examples of such materials are Na-beta alumina, LiHfPO₄ and NASICON, Nasiglass, Li₅La₃Ta₂O₁₂ and Li₅La₃Nb₂O₁₂. Na₅MSi₄O₁₂ (M: rare earth such as Nd, Dy, Gd).

More commonly, the ion membrane architecture is a composite composed of at least two components of different materials having different chemical compatibility requirements, one chemically compatible with the anode, the other chemically compatible with the exterior; generally ambient air or water, and/or battery electrolytes/catholytes. By “chemical compatibility” (or “chemically compatible”) it is meant that the referenced material does not react to form a product that is deleterious to battery cell operation when contacted with one or more other referenced battery cell components or manufacturing, handling, storage or external environmental conditions. The properties of different ionic conductors are combined in a composite material that has the desired properties of high overall ionic conductivity and chemical stability towards the anode, the cathode and ambient conditions encountered in battery manufacturing. The composite is capable of protecting an active metal anode from deleterious reaction with other battery components or ambient conditions while providing a high level of ionic conductivity to facilitate manufacture and/or enhance performance of a battery cell in which the composite is incorporated.

Referring to FIG. 4B, the protective membrane architecture can be a composite solid electrolyte 134 composed of discrete layers, whereby the first material layer 412 (also sometimes referred to herein as “interlayer”) is stable to the active metal anode 132 and the second material layer 414 is stable to the external environment. Alternatively, referring to FIG. 4C, the protective membrane architecture can be a composite solid electrolyte 134 composed of the same materials, but with a graded transition between the materials rather than discrete layers.

Generally, the solid state composite protective membrane architectures (described with reference to FIGS. 4B and 4C) have a first and second material layer. The first material layer (or first layer material) of the composite is ionically conductive, and chemically compatible with an active metal electrode material. Chemical compatibility in this aspect of the invention refers both to a material that is chemically stable and therefore substantially unreactive when contacted with an active metal electrode material. It may also refer to a material that is chemically stable with air, to facilitate storage and handling, and reactive when contacted with an active metal electrode material to produce a product that is chemically stable against the active metal electrode material and has the desirable ionic conductivity (i.e., a first layer material). Such a reactive material is sometimes referred to as a “precursor” material. The second material layer of the composite is substantially impervious, ionically conductive and chemically compatible with the first material. Additional layers are possible to achieve these aims, or otherwise enhance electrode stability or performance. All layers of the composite have high ionic conductivity, at least 10⁻⁷S/cm, generally at least 10⁻⁶S/cm, for example at least 10⁻⁵S/CM to 10⁻⁴S/cm, and as high as 10⁻³S/cm or higher so that the overall ionic conductivity of the multi-layer protective structure is at least 10⁻⁷S/cm and as high as 10⁻³S/cm or higher.

A fourth suitable protective membrane architecture is illustrated in FIG. 4D. This architecture is a composite 134 composed of an interlayer 432 between the solid electrolyte 434 and the active metal anode 132 whereby the interlayer is impregnated with anolyte. Thus, the architecture includes an active metal ion conducting separator layer with a non-aqueous anolyte (i.e., electrolyte about the anode), the separator layer being chemically compatible with the active metal and in contact with the anode; and a solid electrolyte layer that is substantially impervious (pinhole- and crack-free) ionically conductive layer chemically compatible with the separator layer and aqueous environments and in contact with the separator layer. The solid electrolyte layer of this architecture (FIG. 4D) generally shares the properties of the second material layer for the composite solid state architectures (FIGS. 4B and C). Accordingly, the solid electrolyte layer of all three of these architectures will be referred to below as a second material layer or second layer.

A wide variety of materials may be used in fabricating protective composites in accordance with the present invention, consistent with the principles described above.

For example, in the solid state embodiments of Figs. B and C, the first layer (material component), in contact with the active metal, may be composed, in whole or in part, of active metal nitrides, active metal phosphides, active metal halides active metal sulfides, active metal phosphorous sulfides, or active metal phosphorus oxynitride-based glass. Specific examples include Li₃N, Li₃P, LiI, LiBr, LiCl, LiF, Li₂S-P₂S₅, Li₂S-P₂S₅-LiI and LiPON. Active metal electrode materials (e.g., lithium) may be applied to these materials, or they may be formed in situ by contacting precursors such as metal nitrides, metal phosphides, metal halides, red phosphorus, iodine, nitrogen or phosphorus containing organics and polymers, and the like with lithium. A particularly suitable precursor material is copper nitride (e.g., Cu₃N). The in situ formation of the first layer may result from an incomplete conversion of the precursors to their lithiated analog. Nevertheless, such incomplete conversions (also sometimes referred to as composite reaction products) meet the requirements of a first layer material for a protective composite in accordance with the present invention and are therefore within the scope of the invention.

For the anolyte interlayer composite protective architecture embodiment (FIG. 4D), the protective membrane architecture has an active metal ion conducting separator layer chemically compatible with the active metal of the anode and in contact with the anode, the separator layer comprising a non-aqueous anolyte, and a substantially impervious, ionically conductive layer (“second” layer) in contact with the separator layer, and chemically compatible with the separator layer and with the exterior of the anode. The separator layer can be composed of a semi-permeable membrane impregnated with an organic anolyte. For example, the semi-permeable membrane may be a micro-porous polymer, such as are available from Celgard, Inc. The organic anolyte may be in the liquid or gel phase. For example, the anolyte may include a solvent selected from the group consisting of organic carbonates, ethers, lactones, sulfones, etc, and combinations thereof, such as EC, PC, DEC, DMC, EMC, 1,2-DME or higher glymes, THF, 2MeTHF, sulfolane, and combinations thereof. 1,3-dioxolane may also be used as an anolyte solvent, particularly but not necessarily when used to enhance the safety of a cell incorporating the structure. When the anolyte is in the gel phase, gelling agents such as polyvinylidine fluoride (PVdF) compounds, hexafluropropylene-vinylidene fluoride copolymers (PVdf-HFP), polyacrylonitrile compounds, cross-linked polyether compounds, polyalkylene oxide compounds, polyethylene oxide compounds, and combinations and the like may be added to gel the solvents. Suitable anolytes will, of course, also include active metal salts, such as, in the case of lithium, for example, LiPF₆, LiBF₄, LiAsF₆, LiSO₃CF₃ or LiN(SO₂C₂F₅)₂. In the case of sodium, suitable anolytes will include active metal salts such as NaClO₄, NaPF₆, NaAsF₆ NaBF₄, NaSO₃CF₃, NaN(CF₃SO₂)₂ or NaN(SO₂C₂F₅)₂, One example of a suitable separator layer is 1 M LiPF₆ dissolved in propylene carbonate and impregnated in a Celgard microporous polymer membrane.

The second layer (material component) of the protective composite may be composed of a material that is substantially impervious, ionically conductive and chemically compatible with the first material or precursor, including glassy or amorphous metal ion conductors, such as a phosphorus-based glass, oxide-based glass, phosphorus-oxynitride-based glass, sulpher-based glass, oxide/sulfide based glass, selenide based glass, gallium based glass, germanium-based glass, Nasiglass; ceramic active metal ion conductors, such as lithium beta-alumina, sodium beta-alumina, Li superionic conductor (LISICON), Na superionic conductor (NASICON), and the like; or glass-ceramic active metal ion conductors. Specific examples include LiPON, Li₃PO₄.Li₂S.SiS₂, Li₂S GeS₂.Ga₂S₃, Li₂O.11Al₂O₃, Na₂O.11Al₂O₃, (Na,Li)₁₊ₓTi₂₋ₓAlₓ(PO₄)₃ (0.1=x=0.9) and crystallographically related structures, Li₁₊ₓHf₂₋ₓAlₓ(PO₄)₃ (0.1=x=0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M: rare earth such as Nd, Gd, Dy) Li₅ZrP₃O₁₂, Li₅TiP₃O₁₂, Li₃Fe₂P₃O₁₂ and Li₄NbP₃O₁₂, and combinations thereof, optionally sintered or melted. Suitable ceramic ion active metal ion conductors are described, for example, in U.S. Pat. No. 4,985,3 17 to Adachi et al., incorporated by reference herein in its entirety and for all purposes.

A particularly suitable glass-ceramic material for the second layer of the protective composite is a lithium ion conductive glass-ceramic having the following composition:

| Composition | mol % |
|---|---|
| P₂O₅ | 26-55% |
| SiO₂ | 0-15% |
| GeO₂ + TiO₂ | 25-50% |
| in which GeO₂ | 0-50% |
| TiO₂ | 0-50% |
| ZrO₂ | 0-10% |
| M₂O₃ | 0-10% |
| Al₂O₃ | 0-15% |
| Ga₂O₃ | 0-15% |
| Li₂O | 3-25% |

and containing a predominant crystalline phase composed of Liᵢ₊ₓ(M,Al, Ga)ₓ(Ge_{1-y}Ti_{y})₂₋ₓ(PO₄)₃ where X=0.8 and 0=Y=1.0, and where M is an element selected from the group consisting of Nd, Sm, Eu, Gd, Tb, Dy, Ho, Er, Tm and Yb and/or Li_{1+x+y}QₓTi₂₋ₓSi_{y}P_{3-y}O₁₂ where 0<X=0.4 and 0<Y=0.6, and where Q is Al or Ga. The glass-ceramics are obtained by melting raw materials to a melt, casting the melt to a glass and subjecting the glass to a heat treatment. Such materials are available from OHARA Corporation, Japan and are further described in U.S. Pat. Nos. 5,702,995, 6,030,909, 6,315,881 and 6,485,622, incorporated herein by reference.

Another particularly suitable material for the second layer of the protective composite are lithium ion conducting oxides having a garnet like structures. These include Li₆BaLa₂Ta₂O₁₂; Li₇La₃Zr₂O₁₂, Li₅La₃Nb₂O₁₂, Li₅La₃M₂O₁₂ (M═Nb, Ta)Li₇₊ₓAₓLa₃₋ₓZr₂O₁₂ where A may be Zn. These materials and methods for making them are described in U.S. Patent Application Pub. No.: 2007/0148533 (Appl. No: 10/591,714) and is hereby incorporated by reference in its entirety and suitable garnet like structures, are described in International Patent Application Pub. No.: WO/2009/003695 which is hereby incorporated by reference for all that it contains.

The composite should have an inherently high ionic conductivity. In general, the ionic conductivity of the composite is at least 10⁻⁷ S/cm, generally at least about 10⁻⁶ to 10⁻⁵ S/cm, and may be as high as 10⁻⁴ to 10⁻³ S/cm or higher. The thickness of the first precursor material layer should be enough to prevent contact between the second material layer and adjacent materials or layers, in particular, the active metal of the anode. For example, the first material layer for the solid state membranes can have a thickness of about 0.1 to 5 microns; 0.2 to 1 micron; or about 0.25 micron. Suitable thickness for the anolyte interlayer of the fourth embodiment range from 5 microns to 50 microns, for example a typical thickness of Celgard is 25 microns.

The thickness of the second material layer is preferably about 0.1 to 1000 microns, or, where the ionic conductivity of the second material layer is about 10⁻⁷ S/cm, about 0.25 to 1 micron, or, where the ionic conductivity of the second material layer is between about 10⁻⁴ about 10⁻³ S/cm, about 10 to 1000 microns, preferably between 1 and 500 microns, and more preferably between 10 and 100 microns, for example about 20 microns.

The solid electrolyte membrane defines the exterior surface of the protective membrane architecture, and it may have a homogenous composition or a composition that varies with thickness, for instance a graded or discrete variation (e.g., the solid electrolyte membrane itself a laminate composite of multiple layers, having discrete or gradual interfaces).

Compositionally varied solid electrolyte membranes provide benefit in that the surfaces and bulk compositions may be tailored to achieve an optimal membrane as it pertains to chemical compatibility of their respective surfaces in contact with a reference material and bulk conductivity. For example, one particularly suitable solid electrolyte membrane for use in the protected anode has a surface composition with a lithium ion conductivity that is substantially less than that of the bulk membrane composition. By this expedient, the rate of ion exchange between lithium ions in the membrane and sodium ions from the seawater is lessened relative to that for a membrane having a highly conductive surface composition (e.g., that of the bulk composition or higher). For instance, the first surface of the membrane may be composed of a first lithium ion conducting composition, preferably having conductivity in the range of 10⁻⁶ S/cm to 10⁻⁴ S/cm and the bulk composition having conductivity preferably greater than 10⁻⁴ S/cm. Although the surface and bulk must be compositionally different in order to bring about the conductivity difference, it is preferable from the perspective of compatibility and processability that the bulk and surface compositions have some similarity, such as both compositions being a lithium titanium phosphate or both compositions having the same, or similar, crystal structure. For example, a membrane having a bulk composition of LiTi₂(PO₄)₃ (s about 10⁻³ S/cm at room temperature) and a surface composition close to that of the bulk but doped with ions such as Al, Ga, and/or Ge to reduce the conductivity e.g., Liᵢ₊ₓ(Al, Ga)ₓ(Ge_{1-y}Ti_{y})₂₋ₓ(PO₄)₃ (s reduce to below 10⁻⁴ S/cm at room temperature) would be suitable to suppress lithium ion exchange with sodium ions in the seawater.

Inter-Electrode Region

The cell includes an inter-electrode region for receiving seawater from the external environment (e.g., the ocean) in which the cell is activated, and therein the seawater directly contacts at least a portion of the protective membrane exterior surface and at least a portion of the cathode active surface. Seawater in the inter-electrode region serves as an electrolytic solution for passing ionic current, as a sink for accepting ions released by the electrodes during discharge, and as a reservoir where discharge products form.

Prior to activation the inter-electrode region is typically devoid of seawater, and may simply be empty space that is ultimately impregnated with seawater when activated, or it may include a material component, such as a polymer, which swells or gels with seawater in contact (e.g., the polymer becoming a seawater gel on activation), or it may include a material component that is displaced from the cell during activation or dissolves away, such as a salt disposed in the gap or in the pores of the cathode.

The inter-electrode region may take on various forms.

A first type of inter-electrode region is defined by the spaced apart relationship between the protected anode and the cathode, and specifically that between the exterior surface of the protective membrane and the cathode active surface, and this inter-electrode region is sometimes referred to as the gap between the electrodes. The gap may be defined by various material structures, including interior and exterior spacer components or an external frame affixed to the electrodes in spaced apart relationship. Some of these are described below.

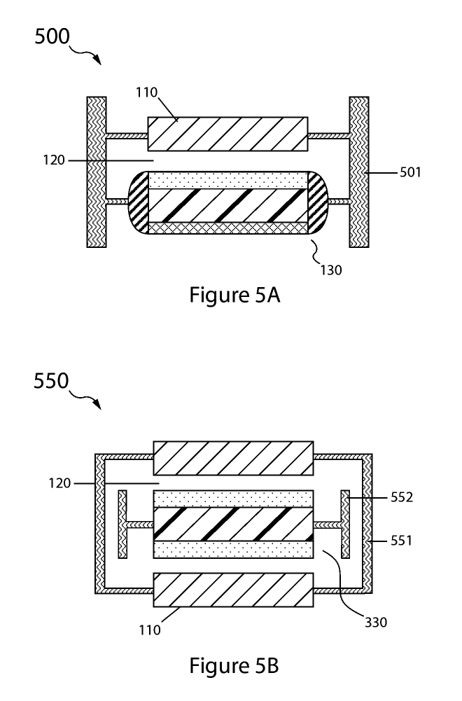

With reference to the battery cell 500 illustrated in FIG. 5A, the electrodes (110 and 130) are affixed to an external frame 501 in a spaced apart relationship, and thus, the gap thickness may change (e.g., increase) during discharge as mass from the anode (e.g., lithium metal) and/or mass from the cathode (e.g., anions) is released into the seawater electrolyte. The electrodes may be attached to a single frame, as illustrated in FIG. 5A, or each may be affixed to a separate external frame independent of the other (i.e., the cathode 110 affixed to a first external frame 551 and the double sided protected anode 330 affixed to a second frame 552), as illustrated in the battery cell 550 shown in FIG. 5B.

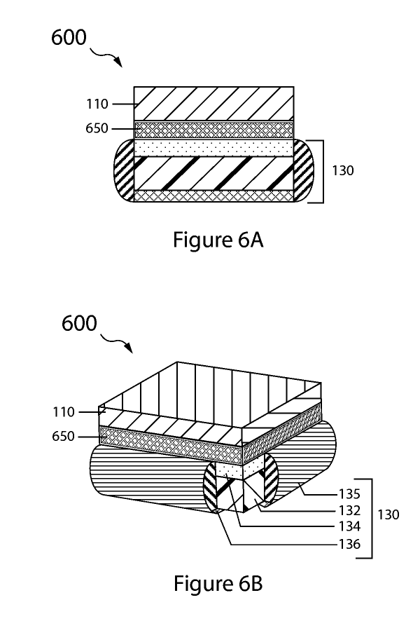

Alternatively, with reference to FIGS. 6A-B, 7A-B, 8A-B, and 9 the gap thickness may be maintained fairly constant over the course of discharge by using a spacer component. In some embodiments the spacer component may be interposed between the electrodes in direct contact with one or both of the opposing electrode active surfaces (i.e., an interior spacer), and in other embodiments the spacer component is positioned outside the perimeter of the electrode active surfaces, and by this expedient does not interfere with the electrochemistry taking plane in the active portion of the cell (i.e., exterior spacer).

Various embodiments of cells having an interior spacer component and those having an exterior spacer component are described below.

With reference to the battery cell 600 illustrated in FIGS. 6A and 6B the spacer component 650 may be a material layer such as porous organic (e.g., polymeric) or inorganic matrix material including cloths, either woven or non-woven, open cell foams, fibrous papers, or hydrophilic micro-porous polymers, hydrogels, water swellable polymers, cellulosic paper. The material layer may be substantially dense prior to the intake of seawater such as when the material layer is a water swellable polymer or hydrogel.

Generally referred to herein as flow retardant layers (e.g., gaskets or membranes) the material layer 650 may have seawater flow retarding properties that suppresses and preferably precludes the bulk motion (bulk flow) of seawater into or through the gap but does not prevent seawater from permeating into the gap via diffusion, capillary action or osmosis. Examples of flow retardant material layer spacers include hydrogels, water swellable polymers, micro-porous polymer membranes inorganic gels (e.g., silica gels), ion selective polymers and ion exchange resins and cellulosic papers. These layers may be used as described above as an interior spacer in direct contact with the electrode active surfaces or as described below as a gasket.

The flow retardant spacers provide a number of benefits. Firstly it provides a mechanism to limit leakage currents associated with seawater serving as a common electrolyte for cells that are series connected in a multi-cell stack; and secondly it provides a mechanism to retain discharge product nearby the active surface of the protected anode in order to lessen the rate of ion exchange between lithium ions in the protective membrane architecture and sodium ions in seawater.

When used, flow retardant spacers may reduce the rate of cell activation, i.e., the time it takes for a sufficient amount of seawater to enter the cell in direct contact with the protective membrane and cathode. In one embodiment the flow retardant spacer (e.g., a flow retardant separator or gasket) juts out of the cell, radially extending beyond the perimeter of the cathode and that of the protected anode, and there disposed in the seawater environment serves as a wick to permeate seawater into the gap.

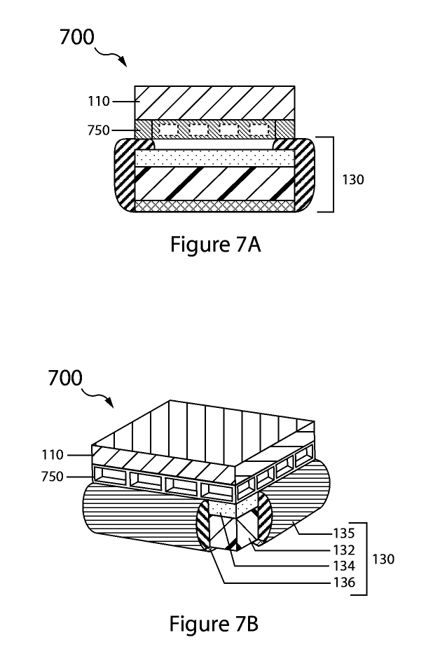

With reference to the battery cell 700 in FIGS. 7A and 7B the spacer component 750 may be a porous frame-like structure positively separating the protected anode 130 from the cathode 110. Preferably the frame is disposed around the periphery of the electrodes to minimize the extent to which it obstructs the active electrode surfaces. For instance, as illustrated in FIG. 5, the frame-like structure may be placed in direct contact with the seal structure 135 (e.g., the compliant seal structure) instead of directly contacting the membrane. The wall thickness of the frame-like spacer should be sufficient for its purpose as a spacer and is preferably made from an inert material that does not react or swell with seawater, including for example polyethylene and polypropylene. Or the spacer component, also frame-like, may be a seawater flow retarding gasket (e.g., a gasket composed of a hydrogel, cellulose, or a microporous polymer).

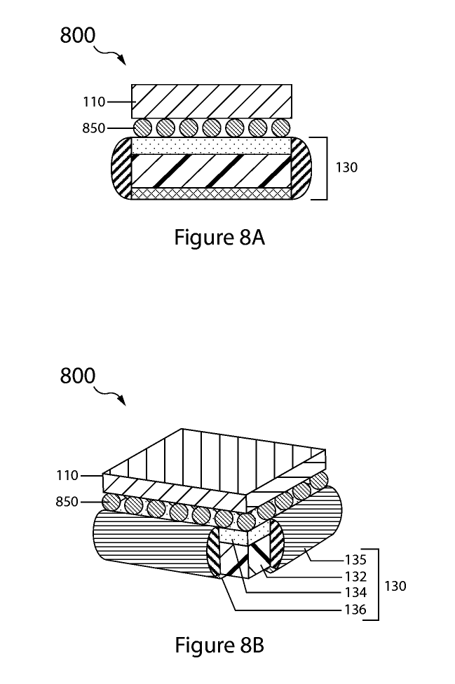

With reference to the battery cell 800 illustrated in FIGS. 8A and 8B the spacer component 850 may be discrete material elements distributed between the electrodes in direct contact with the protective membrane exterior surface and in direct contact with the cathode active surface. Because the membrane is typically flat and hard, the number of spacer elements may be kept to a minimum while still providing adequate positive separation. Thus the percentage of the membrane active area inactivated by the presence of the elements is preferably less than 20%, more preferably less than 10% and even more preferably less than 5%. The spacer elements may be of any geometric shape, typically spherical (e.g., glass, ceramic or polymer beads), and they should be chemically compatible in contact with the cathode active layer and the membrane surface. Preferably the elements are made of a material that will not ion exchange with the membrane, such as inert polymers or glasses devoid of alkali metal ions, especially sodium ions. The interposition of the spacer elements may be arranged randomly or regularly. The spheres, or beads, may be made from a hard material such as glass, but it is preferable to use softer materials such as inert polymers (e.g., polyethylene or polypropylene), which are less likely to damage the solid electrolyte membrane in contact, but sufficiently hard to resist substantial deformation if the cell stack is placed under pressure.

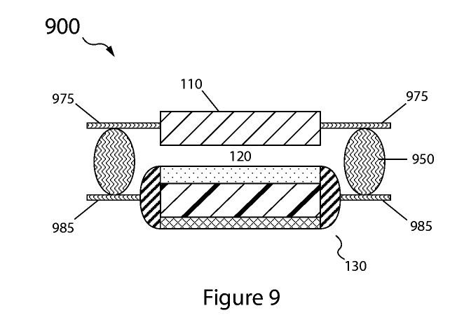

With reference to FIG. 9 the battery cell 900 has a gap 120 (i.e., the spacing between the protected anode and cathode) defined by an exterior spacer component 950 positioned about the exterior of the cell, outside the perimeter of the electrode active surfaces, and there disposed does not directly contact either surface. For instance the spacer 950 may be sandwiched between a pair of spacer support components 975 and 985 each having a support surface and a distal and proximal end. The first spacer support 975 conjoined to the cathode and the second 985 to the protected anode. The proximal ends of the support component are conjoined to their respective electrodes and the distal ends extend radially outward away from the electrodes and the spacer component is sandwiched between the supporting surfaces in direct contact.

The spacer support components may be a polymeric annular disc, e.g., made of polyethylene, conjoined to the electrode in any suitable fashion such as by bonding e.g., with an epoxy. Suitable exterior spacer components 950 include porous frame-like structures, such as an annulus having perforated walls, or the spacer may be a seawater flow retarding gasket, e.g., composed of a hydrogel or seawater swellable polymer, or cellulose or a hydrophilic micro-porous polymer capable of limiting the flow of seawater into the cell and across the gap.

In various embodiments the cell is preloaded with a lithium salt for boosting the conductivity of the electrolytic solution in the inter-electrode region and generally improve performance, especially during start-up wherein the incorporation of the salt enables rapid activation. By use of the term pre-loaded it is meant that the salt is incorporated in the cell prior to activation, typically during manufacture but the invention contemplates that the salt may be added to the cell, e.g., just to prior to activation. For instance, a hydrophilic salt such as LiCl or LiBr disposed in the inter-electrode region. Once the cell is activated the salts dissolve and this boosts the conductivity and improves start-up performance. The incorporation of a salt is also advantageous for cells that are operated in a low salinity external environment (e.g., fresh water or a mixed fresh water/saltwater water environment). As the salt dissolves during activation and thereafter, it significantly increases the lithium ion concentration in the electrolytic solution adjacent to the membrane, and thus is useful to suppress ion exchange between sodium ions in seawater and lithium ions in the solid electrolyte membrane, especially during the early stages of discharge before the concentration of lithium ions builds up over the course of discharge (e.g., wherein the discharge product is a LiCl salt). Moreover, the presence of the hydroscopic salts facilitates seawater permeation into the gap, and thus improves the activation rate (i.e., the time it takes for the cell to be fully activated). The salts may be preloaded in the inter-electrode region (e.g., in the gap) or in the cathode. For instance, the salt may be imbibed within the structure of a material layer spacer component (e.g., a flow retardant spacer) or disposed as a salt compact layer on the surface of the flow retardant layer, e.g., in contact with the membrane exterior surface.

Furthermore, in some embodiments the various material components of the cell may be decorated or coated with hydrophilic elements, such as surfactants which promote wetting and aid in the movement of water into and through inter-electrode region, and therefore can be utilized to enhance activation rate. For instance, fluorocarbons siloxanes, sulfates, sulfonates, phosphates, carboxylates), amines, ammonium based surfactants, fatty alcohols, polyoxypropylene glycol, and ionic surfactants including alkali metal halides (e.g., LiCl).

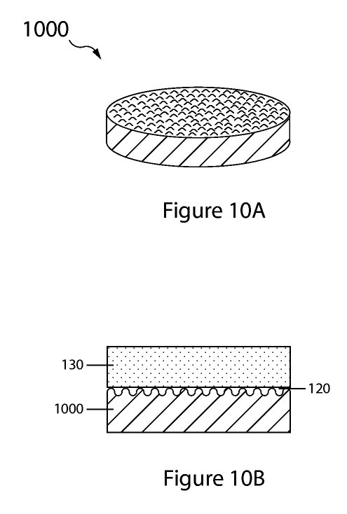

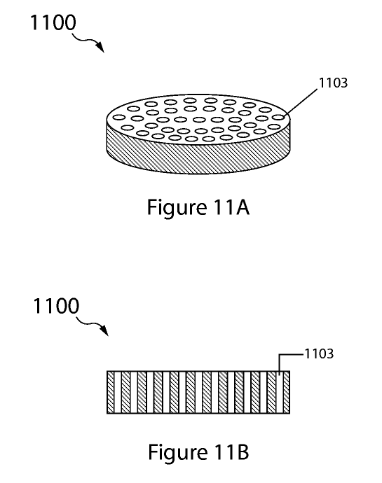

In other embodiments, such as that depicted in FIGS. 2A and 2B, the cell is configured with the protected anode in direct contact with the cathode, specifically the protective membrane exterior surface directly contacting the cathode active surface. Because the electrodes are not spaced apart such cells are sometimes referred to herein as having a zero-gap. However, zero-gap cells are not absent an inter-electrode region. In fact, the inter-electrode region of a zero-gap cell may be formed precisely as a result of the electrodes being in direct contact, wherein the surface morphology of the cathode active surface is different than that of the exterior surface of the solid electrolyte membrane surface. For instance, with reference to the cathode 1000 in FIGS. 10A-B, the cathode active surface may have a rough or corrugated morphology that when mated in direct contact to the relatively smooth surface of the protective membrane 130 creates channels 120 or inter-connected passageways that take up seawater upon activation, or, as illustrated in FIGS. 11A-B, the cathode 1100 may be sufficiently porous, e.g., the cathode perforated with through holes 1103, that serve as the inter-electrode region in the cell. Of course a perforated cathode may be utilized in conjunction with a cell configured having a non-zero gap.

While the invention has thus far been described with respect to cell embodiments each having its own particular type of inter-electrode region, the invention is not intended to be limited as such and it is contemplated herein that cell embodiments in accordance with the invention may have more than one type of inter-electrode region, e.g., a porous cathode and a gap.

Cathode

In accordance with the instant invention the cathode contains a solid phase electro-active component material that is electro-reduced during cell discharge, and is chemically compatible in contact with seawater and is sufficiently resistant to dissolution in water. Typically the solid phase electro-active component material is loaded into the cathode during cathode fabrication.

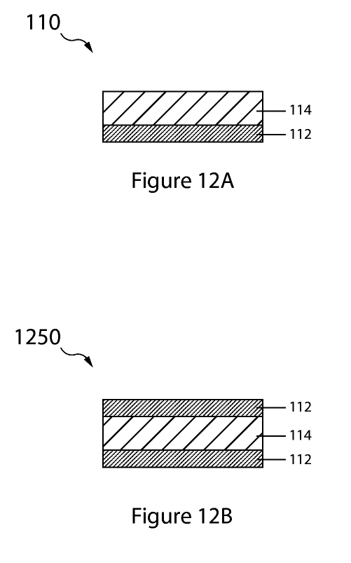

With reference to FIGS. 12 A-B, the cathode is generally sheet-like and may be single sided (FIG. 12A) or double sided (FIG. 12B), which is to mean that the cathode in the form of a layer may have one active surface (i.e., single sided) or both opposing surfaces active (i.e., double sided).

Generally the cathode has two opposing surfaces, and at least one of those surfaces is active. When configured in a cell the cathode active surface typically opposes the exterior surface of the protected anode's protective membrane architecture. Typically the cathode active surface is composed of an electroactive component layer 112 comprising a solid phase electro-active component material (e.g., AgCl).

The single sided cathode 110 may have a current collector 114 adhered to the backside of the electroactive layer 112, with the current collector providing the cathode second surface. Whereas as the double sided cathode 1250 may have a current collector 114 (e.g., silver metal) that is sandwiched between two electro-active layers 112 (e.g., two sheets of AgCl).

To facilitate uniform depletion of lithium during discharge, it is preferable to configure the cell such that the apparent area of the cathode active surface is greater than the apparent area of the protective membrane architecture exterior surface, and for the cathode active surface to radially extend beyond the perimeter of the membrane exterior surface.

In various embodiments the solid electro-active component material is a conversion compound, typically of the metal/non-metal type, which when electro-reduced releases an anion into the seawater as the metal ion of the compound is reduced to the metallic state.

Within the context of a cell having a conversion compound as cathode and lithium as anode, the cell reaction is a displacement that proceeds as follows:

Li+MeX→LiX+Me (wherein Me is a metal and X is a non-metal)

Preferably the anion released (X) and more particularly the discharge product (LiX) is highly soluble, and thus may be allowed to accumulate without precipitating a solid product, or at least not a copious amount of solid product, and by this expedient a cell having a near negligible gap or no gap at all (e.g., a zero-gap cell) may be discharged efficiently at high rates.

Furthermore, retaining dissolved lithium salt discharge product adjacent to the protective membrane can be advantageous for reducing ion exchange between lithium ions of the membrane and sodium ions from the seawater. Accordingly, in various embodiments the gap is constructed with a flow retarding gasket or separator, as described above, that blocks bulk seawater flow and thus enables discharge products to accumulate in the gap to such an extent that the concentration of dissolved lithium ions in the electrolytic solution adjacent to the membrane exceeds, and preferably remains above, the concentration of sodium ions in seawater. Accordingly, in certain embodiments, the cell is configured such that as the discharge proceeds the concentration of dissolved lithium ions nearby or adjacent to the membrane reaches a value of at least 0.2 Molal, and preferably at least 0.5 Molal and even more preferably 1 Molal, and once that value is reached the lithium ion concentration is maintained above it for as long as the discharge proceeds.

When operating the cell in seawater it is preferable to choose a solid electro-active component material that is non-base generating, which is to mean that when it is electro-reduced it does not generate hydroxide ions (OH⁻), which have been found to instigate precipitation of solid salts native to seawater.

Particularly suitable conversion compounds for use herein as a solid electro-active component material are metal halides (or more generally metal halogen compounds), and in particular transition metal halide compounds such as metal chlorides which when electro-reduced in seawater release chlorine ions as the metal ion of the compound is reduced to the metallic state. Once reduced, the metal (e.g., silver or copper) preferably remains in the cathode, where it can be regenerated or otherwise recycled upon removal of the cell from its operating environment. Particular examples are silver chlorides (e.g., AgCl), copper chlorides (e.g., CuCl), lead chlorides (e.g., PbCl), metal iodides (e.g., cuprous iodide) and metal fluorides and mixtures and solid solutions thereof.

Another suitable material for use as the solid electro-active component material in the active layer of the cathode is electronically conductive and/or redox polymers. These polymers may be doped with anions (e.g., Cl⁻) to impart electronic conductivity, and when electro-reduced release anions in order to maintain their overall state of charge neutrality, e.g., polyaniline, polyacetylene, polythiophene and the like.

Other solid phase electro-active component materials suitable for use herein are also contemplated such as intercalation cathode materials that are stable in water. Other suitable solid phase electroactive component materials include potassium persulfate, manganese dioxide, and cuprous thiocynate.

In various embodiments the cathode includes an active layer of the solid-electro-active component material optionally adhered to a current collector. The active layer may be in the form of a compositionally homogenous sheet of solid phase electro-active material or it may be a composite of solid phase electro-active component material particles (e.g., powders) inter-mixed with other components, such as a binder to impart structural integrity and a conductive additive to impart or otherwise enhance electronic conductivity throughout the active layer (e.g., various allotropes of carbon). Preferably the binder is inert and does not swell in contact with seawater (e.g., polymers such as PTFE or PE or PP).

For instance, one example of a single sided cathode suitable for use in the battery cell of the present invention is composed of a copper chloride electro-active layer composed of copper chloride (e.g., CuCl) particles inter-mixed with a polymeric binder, to provide cohesion, and particles of carbon as a conductive additive to enhance the electronic conductivity. The copper chloride active layer may be pressed or slurry coated onto a copper mesh or copper foil current collector. And for instance, one example of a double-sided cathode suitable for use herein as a cathode in a cell of the present invention, is composed of two silver chloride electro-active layers (e.g., each a sheet of AgCl) having a silver metal current collector sandwiched between the layers. Silver chloride is malleable and melt processable and thereby readily fabricated as a sheet absent a binder. The surface of the AgCl may be chemically reduced to impart electronic conductivity to the active surface.

The cathode active layer may be porous or dense, compositionally homogenous or a composite of the solid phase electro-active component material and other component materials such as binders and conductive diluents, as described above. Moreover, the cathode may be single or double sided.

In a specific example the active layer is a dense compositionally homogenous sheet or sinter of silver chloride (AgCl). Silver chloride is malleable, melt processable, and if the surface is somewhat reduced to silver metal has sufficient electronic conductivity that it may be readily fabricated as a sheet absent other components such as a binder or conductive carbon diluent. To enhance current collection and distribution, a current collector (e.g., Ag foil) may be affixed to the back side of the layer, or in the instance where the cathode is intended to be discharged from both surfaces (front and back), the current collector may be sandwiched between two AgCl active layers. Silver chloride active layers may be made dense or porous. Porous AgCl active layers may be fabricated by coating AgCl into or onto a silver mesh as current collector, or the layer punched with through holes to serve as an inter-electrode region within the bulk of the cathode. Perforated with through holes the cathode provides access for seawater to enter and flush through the cell, and thus this configuration may be beneficial for applications for which seawater flow via the cathode is desirable, or in those embodiments wherein the cell has a zero gap, the through holes may provide the majority of the inter-electrode region. Also, substantially dense cathodes (e.g., fully dense AgCl) may be coated with a metal priming layer (e.g., silver metal evaporated or painted). The primer imparts electronic conductivity on the cathode active surface, while the depth of the cathode remains relatively non-conductive. During discharge, as the displacement reaction proceeds, silver begins to form in the depth of the cathode, and as a result high utilization is ultimately attained even though the bulk of the cathode active layer, prior to the start of discharge, was non-conducting. In similar fashion a Cu metal primer may be applied to the surface of dense CuCl cathodes. The primer is not restricted to being the metal of the metal chloride, and the use of other metals is also contemplated herein. For instance, Ag primer painted onto a dense CuCl active layer.

For those applications where the cost of silver chloride is prohibitive alternative compositions, such as copper chloride (e.g., CuCl), may be more suitable. CuCl itself is generally not conductive enough to be used as an active layer absent a conductive additive, and copper chlorides are generally not malleable enough to be pressed into a desired construct without the addition of a binder component to impart cohesion to the layer. Accordingly, copper chloride active layers are generally processed as a composite active layer, typically having a polymeric binder and an allotrope of carbon (e.g., acetylene black). The active layer may be coated onto a copper current collector from CuCl based slurry to a desired thickness depending on the capacity of the cell and the volume percent of CuCl in the layer. The coated layers may be pressed to increase the density of the active layer as needed.

Hybrid Cell Constructs and Hybrid Cathodes

In various applications the battery cell of the present invention may be a hybrid having a cathode composed of a solid phase electro-active component material, such as those described above, and further including an electron transfer medium also capable of efficiently reducing dissolved oxygen when the cell is operated at relatively low discharge rates. The hybrid cell may operate such that below a threshold current density dissolved oxygen depolarizes the cathode and above that threshold the solid phase electro-active component material is electro-reduced. In some embodiments the threshold has a pre-determined range, for instance a lower range under which oxygen is reduced and an upper range above which the solid phase electroactive is reduced.

A hybrid construct may provide a number of advantages. Predominately it allows the cell to be discharged at high rates without generating a copious amount of solid discharge product while extending the overall capacity of the cell because oxygen in the seawater is available in unlimited supply. The instant hybrid construct is particularly suitable for applications that require a continuous low current drain but need an occasional burst of high power.

Hybrid constructs may have a hybrid composite cathode or the cell may have two cathodes, a first cathode for reducing oxygen (i.e., an electron transfer medium) and a second cathode comprising a solid phase electro-active for high rate discharge.

A hybrid composite cathode has both an electron transfer medium and a solid electro-active component material (e.g., AgCl). Such hybrid cathodes may be an intermixed composite, such as a porous carbon fiber electron transfer matrix impregnated with solid phase electro-active material particles (e.g., AgCl). Alternatively the cathode may be divided into discrete regions, a first region providing the solid phase electro-active layer and a second region providing the electron transfer medium. For instance, the hybrid cathode may have a concentric ring structure with the inner region providing the solid phase electro-active material and the outer region the electron transfer medium, or vice-versa. Multiple rings, alternating or otherwise, are also contemplated. The threshold value may be tuned by adjusting the surface area of the electron transfer medium relative to that of the active layer.

It is also contemplated that the cell may have two discrete cathodes, a first cathode composed of a solid phase electroactive component material (e.g., AgCl) and a second cathode, an electron transfer medium (e.g., a carbon electrode composed of platinum black catalyst) for reducing dissolved oxygen. By this expedient the two cathodes may be remotely positioned, one relative to the other, in order to minimize any adverse affects that might otherwise arise if arranged in close proximity.

Multi-Cell Stack

In another aspect the invention provides a multi-cell stack of the instant battery cells, wherein the individual cells are electronically connected to each other in a series, parallel or series-parallel arrangement. A number of embodiments are contemplated and these include various combinations of cells having double or single sided protected anodes in conjunction with double or single sided cathodes as described above. Typically the cells are stacked in a common direction and aligned adjacent to each other in a stack.

Bi-Polar Electrode

In yet another aspect the present invention provides a novel bi-polar protected alkali metal electrode and a bipolar battery thereof (i.e., a lithium water activated multi-cell stack).

The bi-polar electrode is particularly useful for achieving a highly compact and relatively simple multi-cell stack construction, and because the electronic series contact between the cells is derived directly from the bi-polar electrode itself, there is generally no need to run external leads within the bulk of the stack.

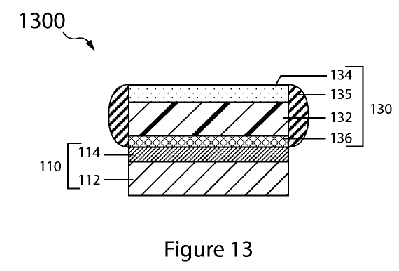

With reference to FIG. 13, the bipolar electrode may be constructed from a single sided cathode 110 interfacing (in electronic contact) with a single sided protected anode 130, therewith the bi-polar electrode has two opposing active surfaces; see for instance the above description of a single sided protected anode FIG. 3A (130) and a single sided cathode FIG. 12A (110). The protected anode active surface (specifically the exterior surface of the protective membrane architecture 134) provides the first active surface of the bi-polar electrode and the second active surface of the bi-polar electrode is provided by the cathode active surface 110.

Continuing with reference to FIG. 13, the current collector of the cathode 114 is conjoined in direct contact with the anode backplane 136, the backplane may be a copper plate serving as current collector for the anode and the exterior surface of the anode backplane in electronic contact with the cathode current collector. Generally the cathode and anode are centroidally aligned such that the backplane is adjacent to and opposes the cathode current collector 114 (e.g., a copper foil). In some embodiments the cathode and protected anode share a common current collector, typically that of the anode backplane, or the current collectors from each may be conjoined in electronic contact, typically via direct contact (i.e., touching contact) or by using an electronically conductive interlayer (e.g., a conducting glue).

For instance, a single-sided protected lithium electrode having a copper plate as anode backplane 136 (e.g., copper plate serving as anode backplane), and the cathode a CuCl layer coated on a copper current (e.g., copper foil). In constructing the bi-polar electrode the cathode and anode are typically centroidally aligned and conjoined via a spot weld or by using a conducting glue. Alternatively, the cathode and protected anode may share a common current collector, e.g., the CuCl layer adhered directly to the anode backplane.

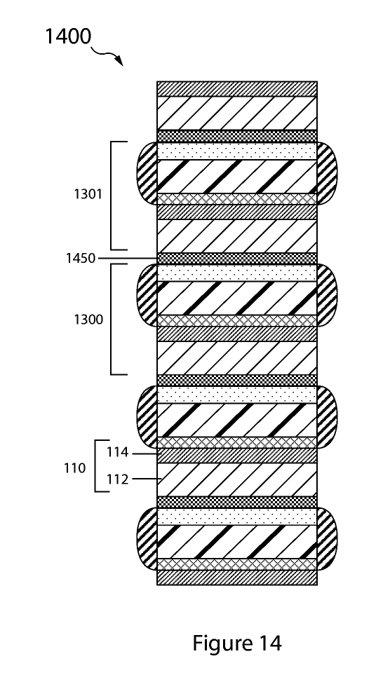

In FIG. 14 there is illustrated a multi-cell bi-polar battery stack 1400 in accordance with the instant invention. The battery 1400 is composed of a plurality of bi-polar electrodes stacked on top of each other but having interposed between them a spacer component 1450 separating the protected anode in a first bi-polar electrode 1300 from direct contact with the opposing cathode in a second bi-polar electrode 1301. Because the cells of the bi-polar stack are series connected, to suppress leakage currents (i.e., shunt currents) a seawater flow retardant membrane may be used as a spacer component between the bi-polar electrodes (i.e., between the protective membrane architecture of a first bi-polar electrode and the cathode of the adjacently positioned bipolar electrode). In an alternative embodiment, not shown, the bipolar electrodes may be stacked with the protective membrane of a first bi-polar electrode in direct contact with the cathode of an adjacent bi-polar electrode, and by this expedient the individual cells in the stack have a zero-gap, and the battery is sometimes referred to as zero-gap bi-polar stack.

Conclusion

Although the foregoing invention has been described in some detail for purposes of clarity of understanding, it will be apparent that certain changes and modifications may be practiced within the scope of the invention. While the invention has been described in conjunction with some specific embodiments, it will be understood that it is not intended to limit the invention to such specific embodiments. On the contrary, it is intended to cover alternatives, modifications, and equivalents as may be included within the spirit and scope of the invention as defined by the appended claims.

Furthermore, although the invention has been described in detail with respect to an ocean external environment, the invention is not intended to be limited as such. Accordingly it is contemplated that the battery cell and multi-cell stacks may be deployed for operation in any natural or man-made body of water, including oceans, seas, lakes, rivers, streams, reservoirs, harbors, waterways, and the like. Also, while the invention has been described in detail with respect to an open cell architecture, it will be apparent to those skilled the art from the disclosure provided herein that cells in accordance with the present invention may also have a closed architecture in which all cell components are contained within the cell's enclosure.

All references cited herein are incorporated by reference for all purposes.

What is claimed is:

1. A water activated alkali metal battery cell comprising:
a protected alkali metal anode, comprising:
an alkali metal electro-active component material hermetically sealed inside an anode enclosure having a wall component comprising an alkali metal ion conductive protective membrane architecture, the membrane architecture having an interior surface opposing the alkali metal electro-active component material and an exterior surface opposing the exterior environment about the anode enclosure;
a cathode having an active surface comprising a solid phase electro-active component material, wherein the cathode is configured such that the cathode active surface opposes the exterior surface of the membrane architecture; and
an inter-electrode region defined by an area contacting the membrane exterior surface and the cathode active surface and configured to receive an aqueous liquid upon activation, such that the aqueous liquid in the inter-electrode region directly contacts the membrane exterior surface and the cathode active surface once the cell is activated.

2. The water activated alkali metal battery cell of claim 1, wherein the cell is substantially devoid of aqueous liquid prior to activation.

3. The water activated alkali metal battery cell of claim 1, wherein the protected anode and cathode are disposed in a spaced apart relationship therewith defining the inter-electrode region, and the protective membrane architecture exterior surface does not come into direct contact with the cathode active surface.

4. The water activated alkali metal battery cell of claim 3 wherein the cathode and protected anode are affixed to one or more external frames, and the spaced apart relationship is defined by the relative position of each electrode on the frame(s).

5. The water activated alkali metal battery cell of claim 4, wherein the protected anode and cathode are positively separated from each other by a spacer component.

6. The water activated alkali metal battery cell of claim 5, wherein the spacer component is interposed between and in direct contact with at least one of the protective membrane architecture exterior surface and the cathode active surface.

7. The water activated alkali metal battery cell of claim 6 wherein the spacer component is selected from the group consisting of a frame-like structure having a porous wall component, a material layer, an arrangement of discrete material elements.

8. The water activated alkali metal battery cell of claim 6 wherein the spacer component is a material layer flow retardant membrane selected from the group consisting of a hydrogel, a water swellable polymer, a micro-porous polymer membrane, and a cellulosic paper.

9. The water activated alkali metal battery cell of claim 8 wherein the flow retardant membrane juts out of the cell, and when disposed in the seawater environment serves as a wick to permeate seawater into the inter-electrode region.

10. The water activated alkali metal battery cell of claim 3, further comprising a pair of spacer support components, each support component having a supporting surface, having a distal end and a proximal end, the proximal end of one support component conjoined to the protected anode and the proximal end of the second support component conjoined to the cathode, wherein the distal ends extend radially away from the electrodes and the spacer component is sandwiched between the supporting surfaces in direct contact.

11. The water activated alkali metal battery cell of claim 10 wherein the spacer component is selected from the group consisting of a frame-like structure having a porous wall component, an arrangement of discrete material elements, and a seawater flow retardant gasket.

12. The water activated alkali metal battery cell of claim 10 wherein the spacer component is a seawater flow retardant gasket selected from the group consisting of a hydrogel, water swellable polymer, a micro-porous polymer, and a cellulosic paper.

13. The water activated alkali metal battery cell of claim 1 wherein the cell further comprises a solid phase hydroscopic lithium salt, whereby at least a portion of the salt dissolves into the aqueous liquid upon activation.

14. The water activated alkali metal battery cell of claim 13 further comprising a flow retardant separator membrane between the cathode and protected anode, and wherein the solid phase hydroscopic lithium metal salt is compacted in direct contact with the flow retardant membrane.

15. The water activated alkali metal battery cell of claim 1, wherein the protective membrane exterior surface directly contacts the cathode active surface.

16. The water activated alkali metal battery cell of claim 15, wherein the morphology of the cathode active surface is different than the morphology of the protective membrane exterior surface, and the inter-electrode between the electrodes is an interconnected network of channels for receiving seawater.

17. The water activated alkali metal battery cell of claim 1 wherein the solid phase electro-active component material is a conversion compound.

18. The water activated alkali metal battery cell of claim 1 wherein the solid phase electro-active component material is a metal halogen compound.

19. The water activated alkali metal battery cell of claim 18 wherein the metal halogen is selected from the group consisting of metal chlorides, metal iodides and metal fluorides.

20. The water activated alkali metal battery cell of claim 18 wherein the metal halogen is a meta chloride selected from the group consisting of silver chloride and copper chloride.

21. The water activated alkali metal battery cell of claim 1 wherein the product of discharge is an alkali metal salt highly soluble in the aqueous liquid of the external environment.

22. The water activated alkali metal battery cell of claim 1, wherein the apparent area of the cathode active surface is greater than the apparent area of the protective membrane architecture exterior surface and radially extends beyond the perimeter of the membrane exterior active surface.

23. The water activated alkali metal battery cell of claim 1 wherein the external environment comprises seawater and the cell is activated by immersion or submergence into the external environment and the aqueous liquid which enters the cell upon activation is seawater from the external environment.

24. The water activated alkali metal battery cell of claim 1 wherein the alkali metal is lithium.

25. The water activated alkali metal battery cell of claim 24, wherein the lithium electroactive component material is selected from the group consisting of lithium metal, lithium alloys, and lithium intercalation materials.

26. The water activated alkali metal battery cell of claim 1 wherein the cell is a hybrid construct comprising an electron transfer medium catalyzed for electro-reducing dissolved oxygen from the external environment in which the cell operates.

27. The water activated alkali metal battery cell of claim 26 wherein the electron transfer medium is electronically connected to but not in direct contact with the solid phase electro-active component material.

28. A multi-cell battery stack comprising a first battery cell electronically connected to a second battery cell, wherein the first battery cell comprises
a protected alkali metal anode, comprising:
an alkali metal electro-active component material hermetically sealed inside an anode enclosure having a wall component comprising an alkali metal ion conductive protective membrane architecture, the membrane architecture having an interior surface opposing the alkali metal electro-active component material and an exterior surface opposing the exterior environment about the anode enclosure;
a cathode having an active surface comprising a solid phase electro-active component material, wherein the cathode is configured such that the cathode active surface opposes the exterior surface of the membrane architecture; and
an inter-electrode region for receiving aqueous liquid upon activation;
wherein the second battery cell is substantially identical to the first battery cell; and
further wherein the electronic connection between the first and second battery is selected from the group consisting of a series electrical connection, a parallel electrical connection and a series-parallel electrical connection.

29. A bipolar protected electrode having two opposing active surfaces, the electrode comprising:
a single sided protected anode having an active surface and a second opposing surface; and
a single sided cathode having an active surface and a second opposing surface;
wherein the protected anode active surface provides the bipolar electrode first active surface and the cathode active surface provides the bipolar electrode second active surface.

30. The bipolar protected electrode of claim 29 wherein the protected anode and cathode are centroidally aligned such that the second surface of the protected anode is adjacent to and opposes the second surface of the cathode, and further wherein the second surfaces are electronically conductive.

31. A bipolar battery comprising at least two bi-polar electrodes as described in claim 29, wherein a first and a second bipolar electrode are configured such that the protected anode active surface of the first bipolar electrode is adjacent to and opposes the cathode active surface of the second bipolar electrode.

32. The bipolar battery of claim 31 wherein the first and second bipolar electrodes are positively separated from each other by a flow retardant layer.
